(19) United States
(12) Patent Application Publication
(10) Pub. No.: US 2012/0157003 A1
(43) Pub. Date: Jun. 21, 2012

(54) INFORMATION APPARATUS, ELECTRONIC DEVICE, AND METHOD FOR CONTROLLING INFORMATION APPARATUS

(75) Inventor: Tatsuyoshi NOMA, Tokyo (JP)

(73) Assignee: KABUSHIKI KAISHA TOSHIBA, Tokyo (JP)

(21) Appl. No.: 13/312,120

(22) Filed: Dec. 6, 2011

(30) Foreign Application Priority Data
Dec. 16, 2010 (JP) P2010-280957

(51) Int. Cl. H04B 17/00

(52) U.S. Cl. 455/67.11

(57) ABSTRACT

An information apparatus includes: a receiving module; a wireless connecting module; a processing ability detecting module; and an outputting module. The receiving module receives a message. The wireless connecting module wirelessly connects with an electronic device. The processing ability detecting module detects, when receiving a request for transmitting the message from the electronic device, a message processing ability of the electronic device using a table. The outputting module outputs a message according to the detected message processing ability toward the electronic device.

CROSS REFERENCE TO RELATED APPLICATION(S) The present disclosure relates to the subject matters contained in Japanese Patent Application No. 2010-280957 filed on Dec. 16, 2010, which are incorporated herein by reference in its entirety.

### FIELD

An embodiment of the present invention relates to an information apparatus, an electronic device, and a method for controlling an information apparatus.

### BACKGROUND

Recently, wirelessly connectable electronic devices are widely used.

An information apparatus which is to be connected to, for example, a public telephone line can obtain a message which is transmitted through a public telephone line, such as a fax message or a message which is recorded in an answering machine by a caller (hereinafter, such a message is referred to as a telephone message).

However, an electronic device which is not to be connected to a public telephone line cannot easily obtain a message which is transmitted through a public telephone line (such as a fax message or a telephone message).

Therefore, there is a request for, also in an electronic device which is not to be connected to a public telephone line or the like, easily obtaining a message which is transmitted through a public telephone line or the like, and a problem of satisfying the request is raised.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a view showing an example of the system configuration of an information apparatus of an embodiment.

FIG. 2 is a view showing an example of the system configuration in which an electronic device is Wi-Fi connected to the information apparatus of the embodiment.

FIG. 3 is a block diagram showing an example of the configuration of the information apparatus (cradle) of the embodiment.

FIG. 4 is a view showing an example of a message display of the electronic device which is Wi-Fi connected to the information apparatus of the embodiment.

FIG. 5 is a view showing an example of a table which is generated in the information apparatus (cradle) of the embodiment.

FIG. 6 is a flowchart illustrating the operation of a massage (fax/telephone message) reception process that is performed in an electronic device (pad) which is Wi-Fi connected to the information apparatus of the embodiment.

FIG. 7 is a flowchart illustrating the operation of a table production process in the information apparatus (cradle) of the embodiment.

FIG. 8 is a flowchart illustrating the operation of a message transmission process in the information apparatus (cradle) of the embodiment.

FIG. 9 is a flowchart illustrating the operation of the massage reception process in an electronic device which is Wi-Fi connected to the information apparatus of the embodiment.

### DETAILED DESCRIPTION OF THE EMBODIMENTS

According to one embodiment, there is provided an information apparatus includes: a receiving module; a wireless connecting module; a processing ability detecting module; and an outputting module. The receiving module receives a message. The wireless connecting module wirelessly connects with an electronic device. The processing ability detecting module detects, when receiving a request for transmitting the message from the electronic device, a message processing ability of the electronic device using a table. The outputting module outputs a message according to the detected message processing ability toward the electronic device.

Hereinafter, an embodiment will be described with reference to the drawings.

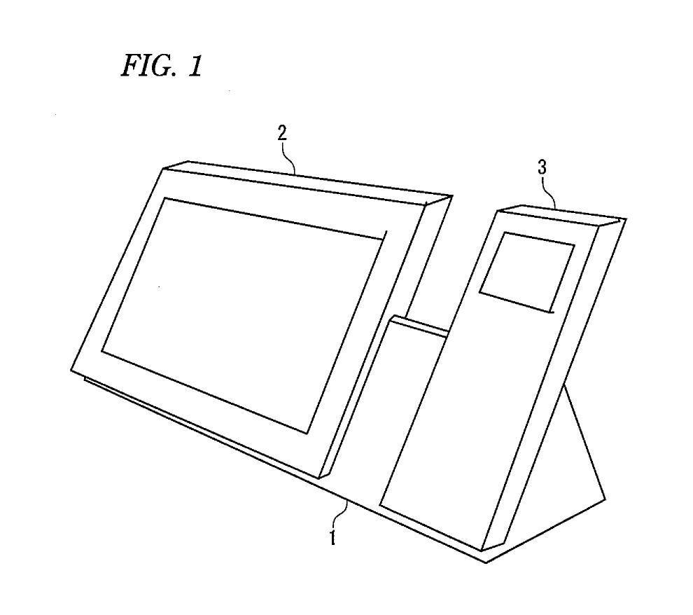

FIG. 1 is a perspective view showing the system configuration of an of the embodiment.

The reference numeral 1 denotes an information apparatus (cradle), 2 denotes an electronic device (pad), and 3 denotes another electronic device (mobile phone).

In the embodiment, the electronic device (pad) 2 and the electronic device (mobile phone) 3 are connected electrically and mechanically to the information apparatus (cradle) 1, and a power source is supplied from the information apparatus (cradle) 1 to the electronic device (pad) 2 and the electronic device (mobile phone) 3.

Moreover, as described later, the information apparatus (cradle) 1 is connected to a broadband router (modem) 7, and can obtain a message (a fax message, a telephone message, or the like) which is transmitted through a public telephone line.

As described above, the electronic device (pad) 2 and the electronic device (mobile phone) 3 are connected electrically and mechanically to the information apparatus (cradle) 1. A message which is obtained by the information apparatus (cradle) 1 can be transmitted to the electronic device (pad) 2 and the electronic device (mobile phone) 3.

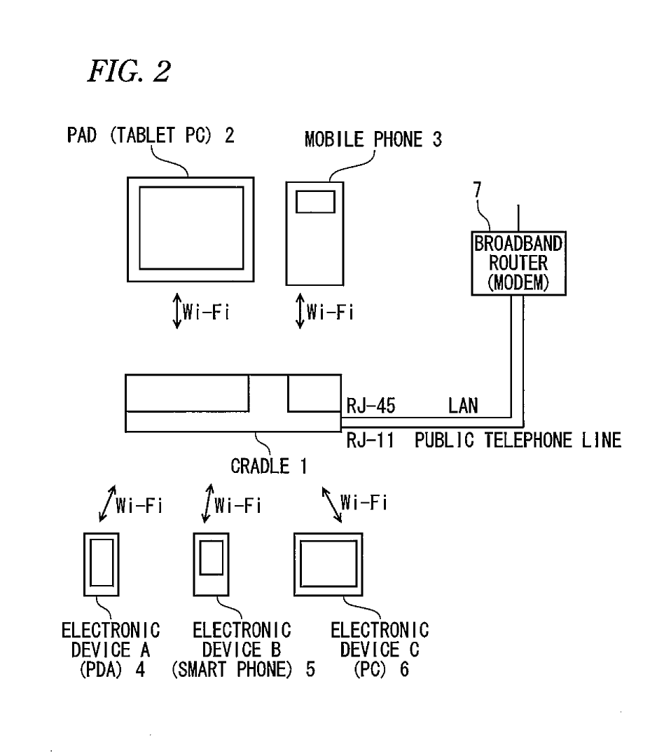

FIG. 2 is a view showing an example of the system configuration in which an electronic device is Wi-Fi connected to the information apparatus of the embodiment.

The reference numeral 4 denotes an electronic device A (PDA), 5 denotes an electronic device B (smart phone), 6 denotes an electronic device C (PC), and 7 denotes the broadband router (modem).

As described above, the information apparatus (cradle) 1 is connected to the broadband router (modem) 7, and can obtain a message (a fax message, a telephone message, or the like) which is transmitted through the public telephone line.

The broadband router (modem) 7 and the information apparatus (cradle) 1 are LAN-connected to each other through an eight-core cable according to, for example, the RJ-45 standard, and connected to the public telephone line through a six-core cable which conforms to the RJ-11 standard, and which is used for a usual telephone line.

Namely, the information apparatus (cradle) 1 is connected to the public telephone line through the cable according to the RJ-11 standard, and a LAN line through the cable according to the RJ-45 standard, to supply the power source to the electronic device (pad) 2 and the electronic device (mobile phone) 3.

In the embodiment, the electronic device (mobile phone) 3 is connected to the information apparatus (cradle) 1 by Detct (wireless (1.9 GHz), the digital method), and includes a small liquid crystal display screen. In the telephone communication mode, the information apparatus (cradle) 1 and the electronic device (pad) 2 are connected to each other by Detct above, and a fax message or a telephone message is stored in the electronic device (pad).

As described above, the electronic device (pad) 2 and the electronic device (mobile phone) 3 are connected electrically and mechanically to the information apparatus (cradle) 1. In the embodiment, furthermore, the electronic devices are Wi-Fi compatible (wireless), and wirelessly connected to the information apparatus (cradle) 1 by Wi-Fi.

In the embodiment, also the electronic device A (PDA) 4, the electronic device B (smart phone) 5, and the electronic device C (PC) 6 are Wi-Fi (wireless communication) compatible, and are wirelessly connected to the information apparatus (cradle) 1 by Wi-Fi.

As described later, the information apparatus (cradle) 1 operates as an access point, and the electronic devices (the pad 2, the mobile phone 3, the PDA 4, the smart phone 5, the PC 6, etc.) which are wirelessly connected to the information apparatus (cradle) 1 by Wi-Fi can obtain, for example, the above-described message (a fax message or a telephone message) and the like which are obtained by the information apparatus (cradle) 1, via the information apparatus (cradle) 1.

Here, Wi-Fi will be described. “Wi-Fi (Wireless Fidelity)” is a term indicating that mutual connectivity between wireless LAN devices is authenticated by the Wi-Fi Alliance. “Wi-Fi” is often expressed also as “WiFi”.

Today, the function of Wi-Fi is incorporated into a mobile computing device such as a notebook personal computer, a portable gaming machine, a music player, a digital camera, and other electronic devices.

Since mutual connectivity between electronic devices of different manufacturers is ensured by Wi-Fi, various electronic devices such as a computer, a mobile phone, and a PDA can be connected to the Internet by using a wireless LAN through, for example, an access point.

When connected to an access point in which mutual connectivity is ensured by Wi-Fi, various wireless LAN devices such as an Internet telephone and a gaming machine can be used by connecting to the access point in addition to the Internet.

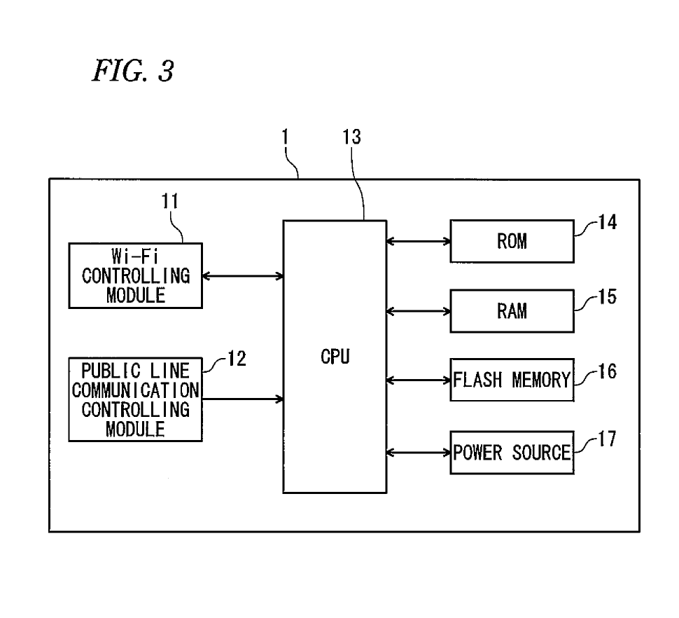

FIG. 3 is a block diagram showing an example of the configuration of the information apparatus (cradle) of the embodiment.

The reference numeral 11 denotes a Wi-Fi controlling module, 12 denotes a public line communication controlling module, 13 denotes a CPU, 14 denotes a ROM, 15 denotes a RAM, 16 denotes a flash memory, and 17 denotes a power source.

Electric power is supplied from the power source 17 to the information apparatus (cradle) 1. The power source 17 may be a commercial power source or a battery.

In the information apparatus (cradle) 1, wireless communication which is wirelessly connected by the electronic device by Wi-Fi is received by the Wi-Fi controlling module 11, and then sent to the CPU 13.

In the information apparatus (cradle) 1, moreover, public telephone line communication which is connected to the public telephone line is received by the public line communication controlling module 12, and then sent to the CPU 13.

The CPU 13 uses the ROM 14, the RAM 15, the flash memory 16, and the like to control the Wi-Fi controlling module 11 and the public line communication controlling module 12.

In the embodiment, a message (a fax message, a telephone message, or the like) which is received by the public line communication controlling module 12 through the public telephone line is converted to, for example, the text format, and then stored in the flash memory 16.

Then, the message (a fax message, a telephone message, or the like) which is stored in the flash memory 16 is stored in a storage module (not shown) of the electronic device (pad) 2 which is connected wirelessly or electrically and mechanically to the information apparatus by Wi-Fi.

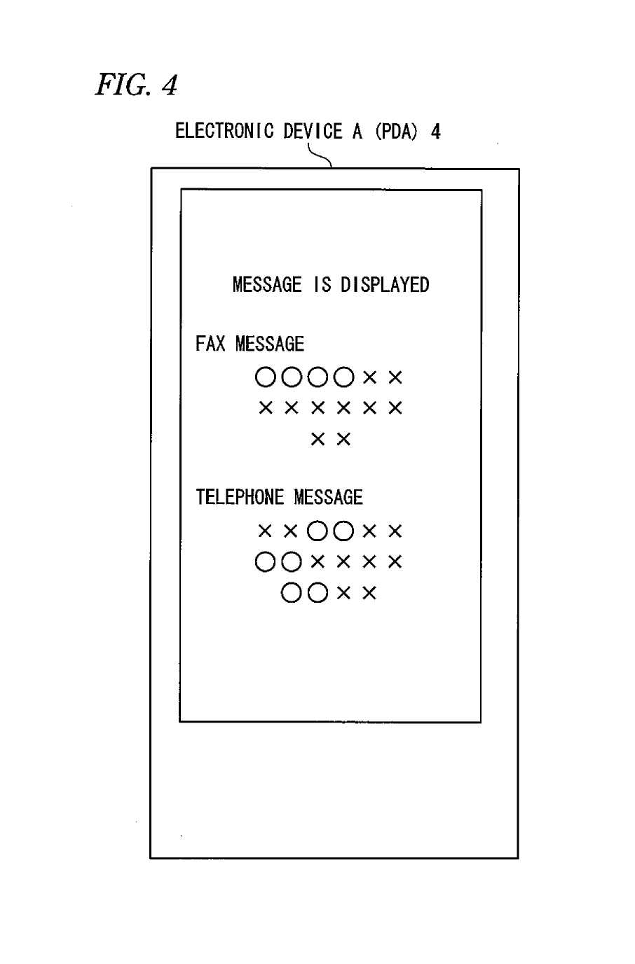

FIG. 4 is a view showing an example of a message display of the electronic device which is Wi-Fi connected to the information apparatus of the embodiment.

In the embodiment, as described above, an electronic device which is Wi-Fi connected to the information apparatus can obtain a message (a fax message, a telephone message, or the like) which is obtained by the information apparatus 1 through the public telephone line, from the information apparatus 1, and output it.

When the information apparatus 1 receives from the electronic device A (PDA) a request for transmitting a message, for example, the information apparatus reads out a message in the text format stored in the storage module of the electronic device (pad) 2, and transmits the message to the electronic device A (PDA).

The electronic device A (PDA) receives the message in the text format.

Here, the electronic device A (PDA) is compatible with a display output of a message, or namely includes software for outputting a message of the text format.

Then, the electronic device decodes the message of the text format, and outputs a display as shown in, for example, FIG. 4.

Here, “Message is displayed”, “Fax message OOOOxxxxxxxxxx”, and “Telephone message xxOOxxOOxxxxOOxx” are displayed.

The manner of outputting a massage is not limited to such a display. For example, a received text message may be converted to a voice message, and then output.

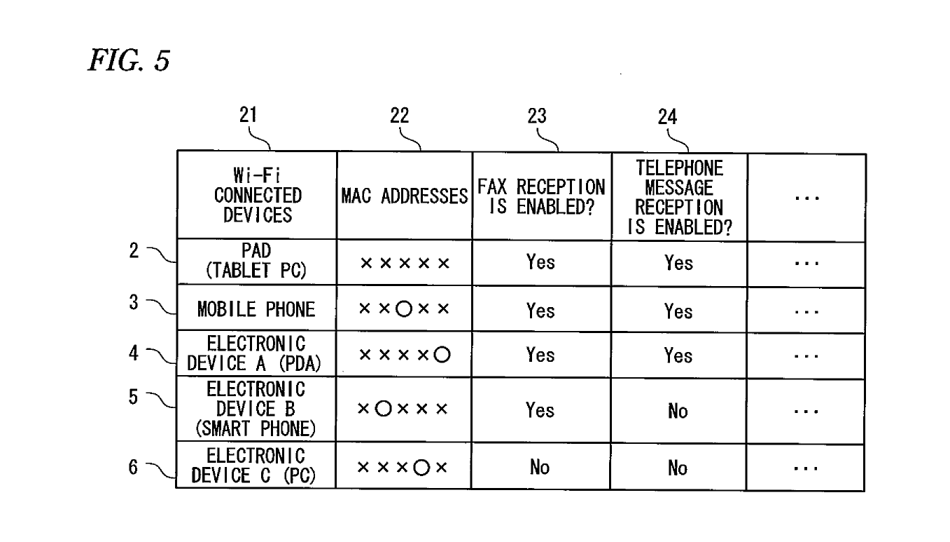

FIG. 5 is a view showing an example of a table which is generated in the information apparatus (cradle) of the embodiment.

Each time when the information apparatus 1 and the electronic device are Wi-Fi connected to each other, for example, information contained in the table is obtained, and the table is updated.

The column denoted by 21 is a column for electronic devices which are to be Wi-Fi connected to the information apparatus 1. Here, for example, the electronic devices are the electronic device (pad) 2, the electronic device (mobile phone) 3, the electronic device A (PDA) 4, the electronic device B (smart phone) 5, and the electronic device C (PC) 6.

The column denoted by 22 shows the Mac addresses of the electronic devices.

Here, the Mac addresses corresponding to each of the electronic devices shown in the above order are “xxxxx”, “xxOxx”, “xxxxO”, “xOxxx”, and “xxxOx”, respectively.

The column denoted by 23 shows information indicating whether the respective electronic devices can perform fax reception or not.

Whether each electronic device can perform fax reception or not is determined depending on, for example, whether or not the objective electronic device includes software for decoding a message of the text format which is transmitted from the information apparatus and displaying the message.

The sets of information indicating whether the respective electronic devices can perform fax reception or not, in the above order are “Yes”, “Yes”, “Yes”, “Yes”, and “No”, respectively.

The column denoted by 24 shows information indicating whether the respective electronic devices can receive a telephone message or not.

Whether each electronic device can receive a telephone message or not is conducted depending on, for example, whether or not the electronic device includes software for decoding a message related to a telephone message which is transmitted from the information apparatus and displaying the message in the form of voice or image.

The sets of information indicating whether the respective electronic devices can receive a telephone message or not, in the above order are “Yes”, “Yes”, “Yes”, “No”, and “No”, respectively.

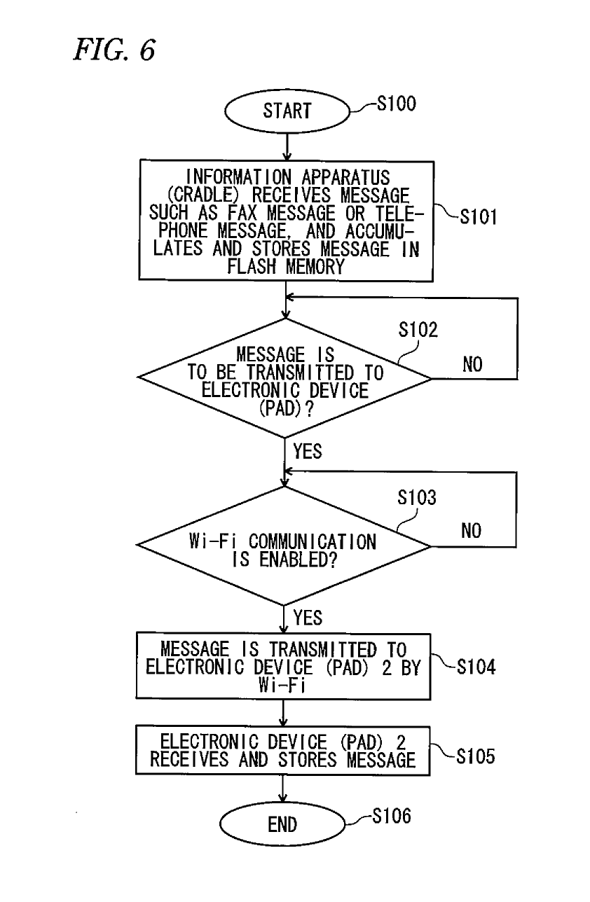

FIG. 6 is a flowchart illustrating the operation of a massage (fax/telephone message) reception process that is performed in the electronic device (pad) which is Wi-Fi connected to the information apparatus of the embodiment.

The reference numeral S100 denotes the starting step of the process. Then, the process proceeds to step S101.

Step S101 is a step in which the information apparatus (cradle) receives a message such as a fax message or a telephone message, and accumulates and stores the message in the flash memory. Then, the process proceeds to step S102.

Step S102 is a step of determining whether the message is to be transmitted to the electronic device (pad) 2 or not. If it is determined that the message is to be transmitted to the electronic device (pad) 2, the process proceeds to step S103 (Yes). If it is not determined that the message is to be transmitted to the electronic device (pad) 2, the process of the step is repeated (No).

Step S103 is a step of determining whether the information apparatus 1 and the electronic device (pad) 2 can be Wi-Fi communicated to each other or not. If it is determined that the information apparatus 1 and the electronic device (pad) 2 can be Wi-Fi communicated to each other, the process proceeds to step S104 (Yes). If it is not determined that the information apparatus 1 and the electronic device (pad) 2 can be Wi-Fi communicated to each other, the process of the step is repeated (No).

Step S104 is a step in which the message is transmitted to the electronic device (pad) 2 by Wi-Fi. Then, the process proceeds to step S105.

Step S105 is a step in which the electronic device (pad) 2 receives and stores the message. Then, the process proceeds to step S106.

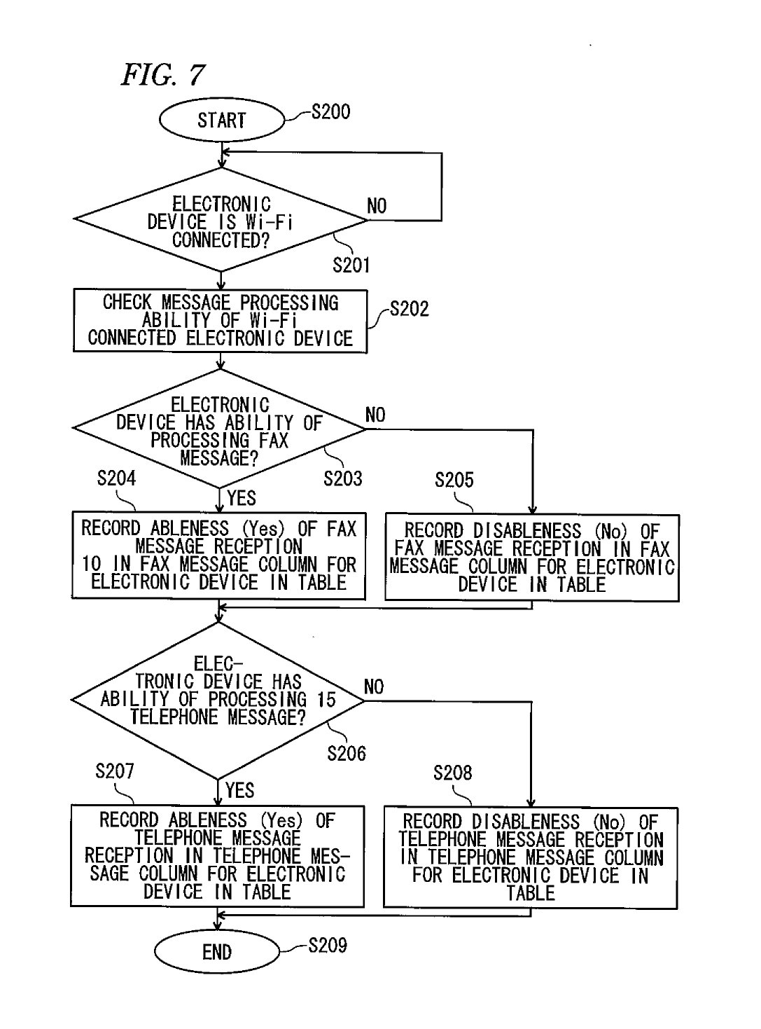

Step S106 is an ending step where the process is ended. FIG. 7 is a flowchart illustrating the operation of a table production process in the information apparatus (cradle) of the embodiment.

The reference numeral S200 denotes the starting step of the process. Then, the process proceeds to step S201.

Step S201 is a step of determining whether the information apparatus 1 is Wi-Fi connected to, for example, anyone of the Wi-Fi compatible electronic devices or not. If it is determined that the information apparatus 1 is Wi-Fi connected to a Wi-Fi compatible electronic device, the process proceeds to step S202 (Yes). If it is determined that the information apparatus 1 is not Wi-Fi connected to a Wi-Fi compatible electronic device, the process of the step is repeated (No).

Step S202 is a step in which the message processing ability of the Wi-Fi connected electronic device is checked as described above. Then, the process proceeds to step S203.

Step S203 is a step of determining whether the electronic device which is Wi-Fi connected as described above has an ability of processing a fax message or not. If it is determined that the Wi-Fi connected electronic device has an ability of processing a fax message, the process proceeds to step S204 (Yes). If it is determined that the Wi-Fi connected electronic device does not have an ability of processing a fax message, the process proceeds to step S205 (No).

Step S204 is a step in which information indicating that fax reception is enabled, or in this example “Yes” is recorded in the Fax column for the Wi-Fi connected electronic device in the table which is set in the information apparatus 1. Then, the process proceeds to step S206.

Step S205 is a step in which information indicating that fax reception is disabled, or in this example “No” is recorded in the Fax column for the Wi-Fi connected electronic device in the table which is set in the information apparatus 1. Then, the process proceeds to step S206.

Step S206 is a step of determining whether the electronic device which is Wi-Fi connected as described above has an ability of processing a telephone message or not. If it is determined that the Wi-Fi connected electronic device has an ability of processing a telephone message, the process proceeds to step S207 (Yes). If it is determined that the Wi-Fi connected electronic device does not have an ability of processing a telephone message, the process proceeds to step S208 (No).

Step S207 is a step in which information indicating that telephone message reception is enabled, or “Yes” is recorded in the telephone message column for the Wi-Fi connected electronic device in the table. Then, the process proceeds to step S209.

Step S208 is a step in which information indicating that telephone message reception is disabled, or “No” is recorded in the telephone message column for the Wi-Fi connected electronic device in the table. Then, the process proceeds to step S209.

Step S209 is an ending step where the process is ended.

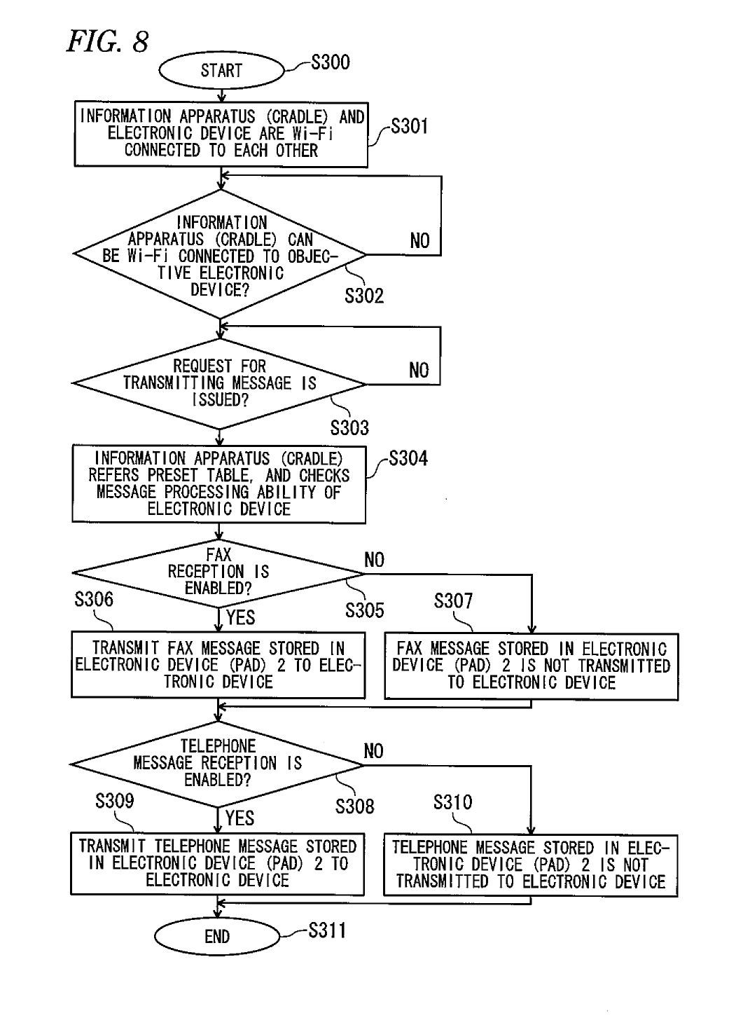

FIG. 8 is a flowchart illustrating the operation of a message transmission process in the information apparatus (cradle) of the embodiment.

The reference numeral S300 denotes the starting step of the process. Then, the process proceeds to step S301.

Step S301 is a step in which the information apparatus (cradle) and the electronic device are Wi-Fi connected to each other. Then, the process proceeds to step S302.

Step S302 is a step of determining whether the information apparatus can be Wi-Fi connected to the objective electronic device or not. If it is determined that the information apparatus can be Wi-Fi connected to the objective electronic device, the process proceeds to step S303 (Yes). If it is not determined that the information apparatus can be Wi-Fi connected to the objective electronic device, the process of the step is repeated (No).

Step S303 is a step of determining whether a request for transmitting a message is issued from the objective electronic device or not. If it is determined that a request for transmitting a message is issued from the objective electronic device, the process proceeds to step S304 (Yes). If it is not determined that a request for transmitting a message is issued from the objective electronic device, the process of the step is repeated (No).

Step S304 is a step in which the information apparatus (cradle) 1 refers the preset table, and checks the message processing ability of the objective electronic device. Then, the process proceeds to step S305.

Step S305 is a step of determining whether the objective electronic device can perform fax reception or not. If it is determined that the objective electronic device can perform fax reception, the process proceeds to step S306 (Yes). If it is not determined that the objective electronic device can perform fax reception, the process proceeds to step S307 (No).

Step S306 is a step in which a fax message stored in, for example, the electronic device (pad) 2 is transmitted to the objective electronic device. In place of the fax message stored in the electronic device (pad) 2, that stored in the information apparatus 1 may be transmitted to the objective electronic device. Then, the process proceeds to step S308.

Step S307 is a step in which the fax message stored in the electronic device (pad) 2 is not transmitted to the electronic device. Then, the process proceeds to step S308.

Step S308 is a step of determining whether the objective electronic device can receive a telephone message or not. If it is determined that the objective electronic device can receive a telephone message, the process proceeds to step S309 (Yes). If it is not determined that the objective electronic device can receive a telephone message, the process proceeds to step S310 (No).

Step S309 is a step in which a telephone message stored in the electronic device (pad) 2 is transmitted to the electronic device. Similarly as described above, in place of the telephone message stored in the electronic device (pad) 2, that stored in the information apparatus 1 may be transmitted to the objective electronic device. Then, the process proceeds to step S311.

Step S310 is a step in which the telephone message stored in the electronic device (pad) 2 is not transmitted to the electronic device. Then, the process proceeds to step S311.

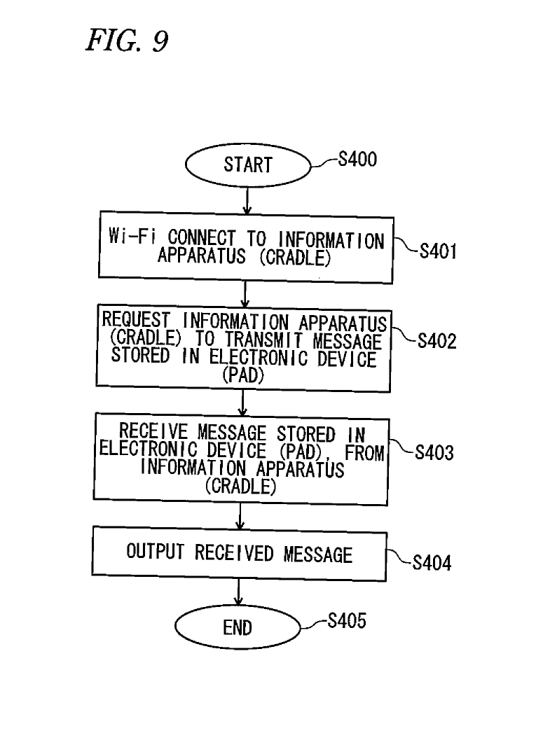

Step S311 is an ending step where the process is ended. FIG. 9 is a flowchart illustrating the operation of the massage reception process in the electronic device which is Wi-Fi connected to the information apparatus of the embodiment.

The reference numeral S400 denotes the starting step of the process. Then, the process proceeds to step S401.

Step S401 is a step in which the objective electronic device is Wi-Fi connected to the information apparatus (cradle) 1. Then, the process proceeds to step S402.

Step S402 is a step in which the information apparatus (cradle) is requested to transmit a message (a fax message or a telephone message) stored in the electronic device (pad). Similarly as described above, in place of a message (a fax message or a telephone message) stored in the electronic device (pad) 2, a message (a fax message or a telephone message) stored in the information apparatus 1 may be transmitted to the objective electronic device. Then, the process proceeds to step S403.

Step S403 is a step in which the message stored in the electronic device (pad) is received from the information apparatus (cradle) 1. Then, the process proceeds to step S404.

Step S404 is a step of outputting the received message. Then, the process proceeds to step S405.

Step S405 is an ending step where the process is ended. In the above, the example in which Wi-Fi is used as the wireless communication has been described. The embodiment is not limited to this. For example, BlueTooth or the like may be used as another example of the wireless communication.

According to the above-described configuration, in the embodiment of the invention, it is possible to easily obtain a message which is transmitted through a line or the line that is not connected to an electronic device.

The embodiment is not limited to the description as it is, and, in the stage of implementation, the invention can be embodied while the components are variously modified without departing the spirit of the invention.

What is claimed is:

1. An information apparatus comprising:
a receiving module configured to receive a message;
a wireless connection module configured to wirelessly connect with an electronic device;
a processing capability detection module configured to use a table to detect a message processing capability of the electronic device in response to receiving a request from the electronic device to transmit the message; and
an output module configured to transmit the message to the electronic device based on the detected message processing capability.

2. The information apparatus of claim 1, wherein the message is transmitted through the wireless connection.

3. The information apparatus of claim 1, wherein the message comprises one of a fax message and a telephone message.

4. The information apparatus of claim 1, wherein the received message is stored in a second electronic device that is connected to the information apparatus, and the stored message is transmitted to the electronic device in response to the request to transmit the message.

5. The information apparatus of claim 1, further comprising a storage module configured to store the message,
wherein the stored message is transmitted to the electronic device in response to the request to transmit the message.

6. The information apparatus of claim 1, wherein the table is generated when the electronic device wirelessly connects with the wireless connection module.

7. An electronic device configured to wirelessly connect to the information apparatus of claim 1, wherein the electronic device comprises a message output module configured to receive and to output the message from the output module.

8. A method for controlling an information apparatus, the method comprising:
receiving a message;
wirelessly connecting to an electronic device;
in response to a request from the electronic device to transmit the message, using a table to detect a message processing capability of the electronic device; and
transmitting the message to the electronic device based on the detected message processing capability of the electronic device.
